(19) United States
(12) Patent Application Publication
(10) Pub. No.: US 2025/0380342 A1
(43) Pub. Date: Dec. 11, 2025

(54) APPARATUSES FOR ABSORBING HIGH-FREQUENCY, HIGH-POWER MICROWAVE BEAMS

(71) Applicant: Consiglio Nazionale delle Ricerche, Roma (RM) (IT)

(72) Inventors: William BIN, Cornaredo (MI) (IT); Alessandro BRUSCHI, Solaro (MI) (IT)

(21) Appl. No.: 18/874,610

(22) PCT Filed: Jun. 21, 2023
(86) PCT No.: PCT/IB2023/056415

§ 371 Date: Dec. 13, 2024

(30) Foreign Application Priority Data
Jun. 22, 2022 (IT) 102022000013192

(51) Int. Cl. H05B 6/64; G21B 1/23

(52) U.S. Cl. CPC H05B 6/64; G21B 1/23

(57) ABSTRACT

An apparatus for absorbing microwave beams may include: a load; and a deflection device. The load may be a bolometric device, including: a first body with a first cavity including a first opening for entry of a microwave beam; and a scattering element configured to reflect the microwave beam toward an internal surface of the first cavity. The deflection device may include a second body comprising a second cavity that includes second and third openings. The second opening may be connected with the first opening. The third opening may connect with transmission lines to transport the microwave beams to the deflection device. The second cavity may include a first converging mirror configured to intercept the microwave beam; and a second converging mirror configured to deflect the microwave beam toward the first opening. An optical path length between the converging mirrors is substantially equal to a sum of their focal lengths.

The present invention relates to an apparatus for absorbing microwaves in the form of high-frequency, high-power microwave beams comprising a bolometer load and a deflection device.

In the state of the art, fusion energy research is carried out using magnetically confined thermonuclear plasmas through a plurality of different types of devices, of which the most promising appears to be a tokamak, as for example described in Angelone G. et al.: “Transmission lines for ECRH experiments on FTU tokamak”, Fusion Engineering, 1997, 17th IEEE/NPSS Symposium San Diego, CA, USA 6-10 Oct. 1997, New York, NY, USA, IEEE, US, vol. 1, 6 Oct. 1997.

The tokamak consists of a vacuum toroidal chamber wherein thermonuclear plasma is magnetically confined and heated to maintain the plasma temperature at the value required for nuclear fusion processes.

The tokamak comprises external heating systems to support the nuclear fusion process in a stationary state.

Heating systems comprise a primary ohmic heating by means of an induced current flow useful for plasma confinement and heating systems comprising an injection of powerful microwave beams. Microwave beams carry high power that is supplied by sources, e.g. gyrotrons, and is transmitted to a reactor by a waveguide or mirror transmission line.

This high power is injected into the plasma to heat it by means of a wave-particle absorption process. Sources and transmission lines need to be commissioned and conditioned day by day on adapted loads capable of absorbing the power of the low-reflection microwave beam.

Low reflection refers to the components of the microwave beam that are reflected on the internal walls of the load and become scattered radiation that diffuses outwards from the load cavity through the load opening at any angle allowing it to pass through the load opening.

Currently, the majority of gyrotrons and loads are designed for 170 GHz, the operating frequency of the most reactor important experimental fusion ITER (International Thermonuclear Experimental Reactor). Only a few high-power loads are currently available on the market.

An example of a load is described in Bin et al.: “Advances in high power calorimetric matched loads for short pulses and CW gyrotrons”, Fusion Engineering and Design, Elsevier Science Publishers, Amsterdam, NL, vol. 82, no. 5-14, 1 Oct. 2007.

Disadvantageously, the use of loads adapted to cavities with a scattering mirror, which are designed and tested especially for high powers and frequencies, cannot be extended to very different frequencies and microwave beams with characteristics that differ from those of the design. In fact, the spot size of the Gaussian beam (evaluated at the surface of a load scattering mirror) depends on the frequency of the radiation and is one of the main input parameters for the correct design of the load. Adaptation to different frequencies, or even multi-frequency applications, of loads designed for 170 GHz would not be trivial and could only be possible by introducing significant modifications to the load structure. However, such design changes will result in a significant loss of know-how, which at present is closely related to the layout used for 170 GHz and is the result of many years of experience and experimentation also carried out by the ISTP (Institute for Plasma Science and Technology) of the Italian National Research Council (CNR). In addition, changes to the load design would also result in a significant increase in costs for the development of new prototypes with different properties (such as dimensions, scattering mirror geometry, cooling systems, etc.), which have never been tested so far. This lack of know-how and increased costs would represent a serious limitation to the possibility of supplying loads to fusion laboratories where frequencies other than 170 GHz and/or multi-frequency operations are required.

In Thumm M. et al.: “Progress in the 10-MW 140-GHZ System for the W7-X Stellarator”, IEEE Transactions on Plasma Science, IEEE Service Center, Piscataway, NJ, US, vol. 36, no. 2, 1 Apr. 2008, a system of two co-focal mirrors for realigning off-axis phases is described.

In Jin Jianbo et al.: “A new method for synthesis of beam-shaping mirrors for off-axis incident Gaussian beams”, IEEE Transactions on Plasma Science, IEEE Service Center, Piscataway, NJ, US, vol. 42, no. 5, 1 May 2014, a system with two converging mirrors is described to reshape the beam to maintain a Gaussian distribution.

The object of the present invention is to design a compact microwave absorption apparatus which allows to use a multiplicity of frequencies of a microwave beam and to use a multiplicity of loads designed at different operating frequencies and/or at frequencies lower than those used in the state of the prior art, overcoming the disadvantages of the state of the prior art.

According to the invention, such an object is achieved by a microwave absorption apparatus according to claim 1.

A further object of the present invention is to implement a process for making a compact microwave absorption apparatus which allows to use a multiplicity of frequencies of a microwave beam and to use a multiplicity of different operating frequencies and/or frequencies lower than those used in the state of the prior art by overcoming the disadvantages of the state of the prior art.

According to the invention, such other object is achieved by a method according to claim 14.

Other features are provided in the dependent claims.

The features and advantages of the present invention will be more apparent from the following description, which is to be understood as exemplifying and not limiting, with reference to the appended schematic drawings, in which:

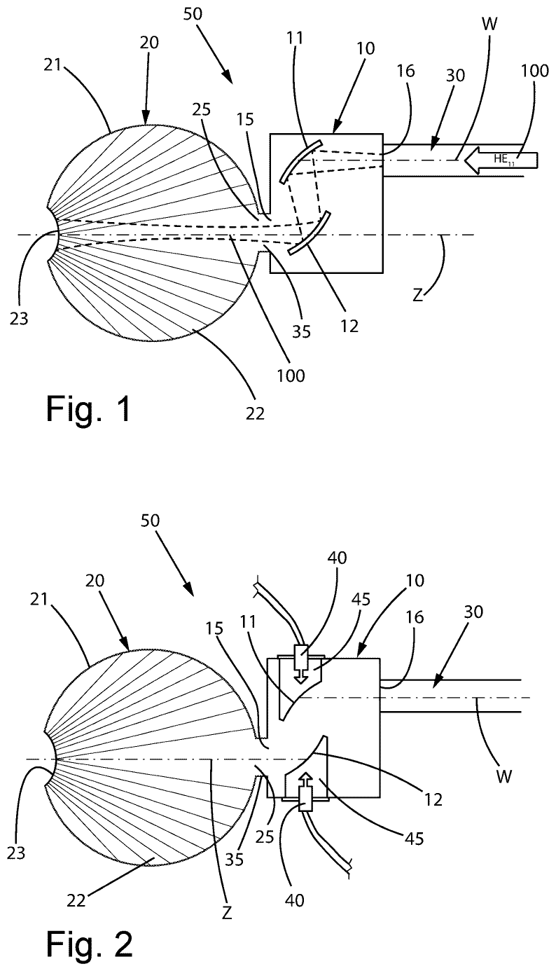

FIG. 1 is a schematic view of a high-frequency, high-power microwave beam absorption apparatus according to the present invention comprising a bolometer load and a deflection device connected to a load opening and a microwave beam transmission line, wherein the edges of the microwave beam are shown as dashed lines, wherein the deflection device comprises two off-axis converging mirrors according to a first configuration;

FIG. 2 is a schematic view of the apparatus with an alternative deflection device comprising two off-axis converging mirrors according to the first configuration that are cooled by a hydraulic circuit;

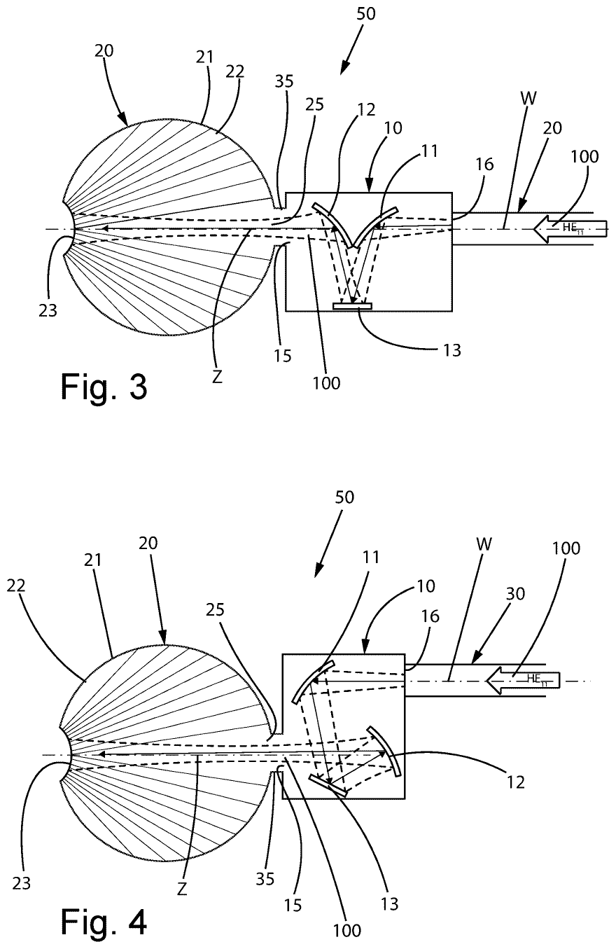

FIG. 3 is a schematic view of the apparatus with an alternative deflection device comprising two off-axis converging mirrors and a plane mirror according to a second configuration;

FIG. 4 is a schematic view of the apparatus with an alternative deflection device comprising two off-axis converging mirrors and a flat mirror according to a third configuration;

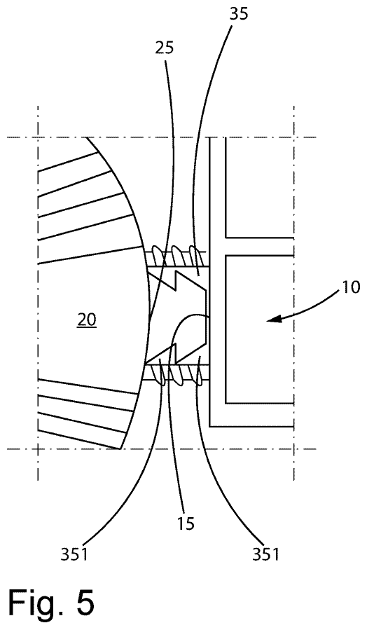

FIG. 5 is a schematic view of a detail of the apparatus showing a connection flange between the load and the deflection device.

With reference to the mentioned figures, an apparatus 50 for absorbing microwaves in the form of high-frequency, high-power microwave beams is shown, comprising a load 20 and a low-reflection deflection device 10 for microwave beams connected to loads 20 adapted to high power for microwave beam sources and transmission lines.

Microwave beams are beams of microwaves 100 entering a load 20 along a direction of incidence Z. The microwave beam 100 diverges to infinity and its divergence depends on the frequencies of the beam. FIGS. 1, 3 and 4 show the edges of the microwave beam with dashed lines, where the divergence is exaggerated with respect to the measurement scale to make it more visible.

The microwaves of the microwave beam 100 are in the frequency range of tens to hundreds of GHz, i.e. the so-called millimetre waves.

High power refers to the order of magnitude of a few MW, i.e. 0.1 to 4 MW, e.g. 1 MW.

High frequencies refer to the order of magnitude of tens to hundreds of GHz, i.e. 30-300 GHZ, i.e. between 1 mm and 10 mm, e.g. 170 GHz.

The deflection device 10 is part of a microwave absorption system.

The microwave absorption system is preferably part of a plasma heating system. The plasma heating system is preferably part of a nuclear fusion reactor.

The plasma heating system comprises sources generating high-power microwave beams 100; transmission lines 30 of the microwave beam 100 adapted to carry the microwave beams 100; the absorption apparatus 50 of the present invention comprising the deflection device 10 connected to the transmission lines 30 of the microwave beam 100 and the load 20 adapted to receive the microwave beam 100 and distribute power thereof to internal surfaces 22 of the load 20, wherein the load 20 is connected to the deflection device 10.

The sources are preferably gyrotrons.

The transmission lines 30 of the microwave beam 100 may for example be optical or quasi-optical transmission lines or waveguides.

The load 20 is a bolometer device with a receiving cavity and comprises a hollow body 21 with a receiving cavity comprising an opening 25 for the entry of the beam into microwave 100 the receiving cavity. Preferably, the opening 25 is arranged along the direction of incidence Z of the incident microwave beam 100.

The load 20 preferably comprises a scattering mirror 23 arranged on a portion of an internal surface 22 of the receiving cavity, wherein said portion is opposite the opening 25 of the cavity and arranged along the direction of incidence Z of the microwave beam 100 as shown in FIGS. 1-4.

The diverging scattering mirror 23 reflects a multiplicity of components of said microwave beam 100 incident towards a multiplicity of angles of reflection directed towards the internal surface 22 of the cavity which is coated with an absorbing material.

The reflected microwave beams are absorbed by the absorbing coating of the cavity. A cooling system is positioned outside the load 20.

This microwave absorption process is particularly preferred when the load 20 is associated with the nuclear fusion reactor.

Advantageously, the load 20 based on a scattering mirror 23 and spherical vacuum cavity is one of the most compact, and is currently considered optimal for use on ITER, so it is the preferred configuration of the present invention.

Preferably the ISTP-designed loads 20 are hollow copper spheres with electro-formed cooling channels and an internal surface 22 coated with a partially reflective ceramic absorber deposited by a plasma spraying technique. They are based on inserting the microwave beam 100 through the opening 25 and scattering by means of the appropriately shaped scattering mirror 23 on the opposite side. The scattered radiation is absorbed on the internal walls 22 of the cavity in the subsequent reflections. The desired uniform thermal load in the load walls 22 is obtained by a correct shape of the scattering mirror 23, the deposition thickness of the coating and multi-reflections of radiation in the cavity. In the case of injection of linearly polarised radiation, such as that typically emitted by gyrotrons, there are physical limits to the possibility of obtaining a homogeneous distribution, due to the different absorption by the coating for reflections in or out of the polarisation plane.

A circular polarisation, on the other hand, would not have this limitation.

Note that the incident microwave beam 100 travels along the transmission line preferably in the form of a propagation mode named HE11.

During propagation in the load 20 the microwave beam 100 expands at an angle inversely proportional to the frequency of the radiation: the size and shape of the scattering mirror 23 are based on the size of the microwave beam 100 and the curvature of the phase front at the position of the mirror 23.

The load 20 with a spherical cavity shown in the figures has, for example, already been successfully used in international fusion laboratories (EPFL, Lausanne, Switzerland and QST, Naka, Japan), at frequencies of 170 GHz.

The deflection device 10 comprises a body comprising a cavity, a first opening 15 of the cavity connected with said opening 25 of the cavity of the load 20 and a second opening 16 of the cavity connected with transmission lines 30 of the microwave beam 100 adapted to transport the microwave beams 100 from a source to the deflection device 10.

The deflection device 10 advantageously intercepts scattered radiation resulting from reflections of the reflected components of the microwave beam on the internal walls of the load 20.

The deflection device 10 reflects back the residual scattered radiation escaping from the cavity of the load 20 without interfering with the entering microwave beam 100.

The cavity of the deflection device 10 comprises therein at least two converging mirrors 11, 12 arranged off-axis.

Off-axis means that the respective focal axes are not on the same axis with each other, or are on the same direction, but along different directions from each other.

The two converging mirrors 11, 12 interpose themselves in the direction of incidence of the microwave beam entering from the transmission line 30 so that the microwave beam exiting the transmission line is not directly led into the cavity of the load 20, but must be deflected at least by the two converging mirrors 11, 12 before entering the cavity of the load 20.

The deflection device 10 is advantageously adapted to intercept the high-angle scattered radiation exiting the opening 25 of the load 20, advantageously preventing the scattered radiation from returning to the source, which could damage the source itself.

As shown in FIGS. 1-4, the converging mirrors 11, 12 are two and are arranged off-axis so that a first converging mirror 11 intercepts the incident microwave beam 100 exiting the transmission line 30 along an output direction W, and so that a second converging mirror 12 intercepts the incident microwave beam 100 by deflecting it along the input direction Z.

The converging mirrors 11, 12 are said to be focusing, i.e. provided with curved surfaces capable of redirecting and reshaping the incident microwave beam (100) in terms of spot size and curvature of a phase front.

Preferably, the focal axis of the first converging mirror 11 is arranged along the output direction W, while the focal axis of the second converging mirror 12 is arranged along the input direction Z.

Preferably convergent mirrors 11, 12 are elliptical mirrors.

Preferably, a length of an optical path of the microwave beam 100 between the two mirrors 11, 12 is equal to the sum of the focal lengths of the two mirrors 11, 12.

As shown in the embodiments of FIGS. 3 and 4 further non-converging mirrors can be inserted along an optical path between the first two mirrors 11, 12 in order to advantageously provide both a change of direction to have a more compact layout and to provide a change of polarisation of the microwave beam 100, functional for a better power distribution within the load 20.

For example, FIG. 3 shows an embodiment where the first mirror 11 makes the microwave beam converge downwards of the cavity of the deflection device 10 where a third mirror 13 is arranged which is a plane mirror whose geometric normal is perpendicular to the input directions Z and output directions W and which reflects the microwave beam towards the second mirror 12 which then leads it along the input direction Z towards the opening 25 of the cavity of the load 20.

For instance, FIG. 4 shows an embodiment where the third mirror 13 is plane and is rotated by an angle relative to the focal direction of the first mirror 11, where the normal of the third plane mirror 13 forms an acute angle with the input direction Z. In this case as well the third mirror 13 reflects the microwave beam 100 back to the second mirror 12, which then deflects it along the input direction Z towards the opening 25 of the cavity of the load 20.

Preferably, the cavity of the deflection device 10 comprises metal walls and is under vacuum to advantageously avoid arcing.

The deflection device 10 advantageously allows the use of loads 20 adapted to cavities with a scattering mirror 23 and preferably an absorbing coating for a multiplicity of frequencies.

Advantageously the deflection device 10 allows to use microwave beams 100 comprising a multiplicity of frequencies.

Advantageously, the deflection device 10 allows to use both beams comprising frequencies used in the state of the prior art and ranging between 140 and 300 GHz, as well as lower frequencies, e.g. frequencies in the order of magnitude of tens of GHz, such as between 30 and 140 GHz.

Advantageously, the deflection device 10 allows to use a multiplicity of frequencies even when the device 10 is associated with already existing loads 20 designed to optimise only one particular frequency, e.g. designed for a frequency of 170 GHz. Advantageously, the deflection device 10 allows to use a multiplicity of different frequencies without having to change the structural part of the existing load 20 and thus without having to redesign the existing load 20.

The deflection device 10 requires an additional distance from the entry 25 of the beam 100 to the mirror 23 of the load 20, which causes an increase in the size of the incident microwave beam 100.

The deflection device 10 can be used to lower the reflection of the load 20 and also has the advantage of providing side access for auxiliary systems, such as a pumping system and an arc detection safety system, and for additional absorbing flanges.

The deflection device 10 can therefore house on its body: a flange for the connection to the transmission line 30, a flange for the connection to the opening 25 of the cavity of the load 20, one or more accesses for an arc detection, where the detectors can be either optical fibres and/or line-of-sight through vacuum windows for cameras in the visible.

An additional flange to be housed on the body of the deflection device 10 can be dedicated to connect a vacuum line for pumping, so as to keep the cavity of the deflection device 10 under vacuum.

The body of the deflection device 10 can house additional flanges to house additional instrumentation, for example to accommodate additional microwave absorption instruments for lowering the level of scattered (dispersed) radiation power, which inevitably propagates backwards in the direction of the input line Z escaping from the opening 25 of the load 20.

Flanges refer to standard vacuum openings of the cavity of the deflection device 10. Preferably, the flanges use metal gaskets (for example metal gaskets are produced under the ConFlat® or Helicoflex® brand names).

Advantageously, the deflection device 10 is a system separated from the load 20 and can be easily decoupled, when necessary, by disconnecting the flange 35 connected to the entry of the opening 25 of the load 20 and in communication with the opening 15 of the cavity of the deflection device 10.

Preferably as shown in FIG. 5 the flange 35 may comprise a vacuum compatible bellows and/or preferably comprise backwardly reflecting inner walls 351, where backward direction means towards the load 20.

In addition, the scattered radiation returning back into the cavity of the deflection device 10 can be reflected a multiplicity of times within the cavity of the deflection device 10, forming a scattered radiation. Some of this scattered radiation is partially intercepted by the transmission line 30 on its way back to the source.

To obviate this situation by reducing the scattering of the reflected components of the microwave beam within the cavity of the deflection device 10, the internal walls of the cavity can be covered with a coating that absorbs the scattered radiation and can be provided, on the outer side, with preferably active integrated cooling circuits.

The inner walls of the cavity of the deflection device 10 refer to the surfaces not occupied for the connection of external components.

Preferably said cavity of the deflection device 10 comprises internal walls comprising a layer of radiation-absorbing material, where the absorbing material is adapted to absorb microwave radiations of a frequency compatible with microwave radiations.

As shown in FIG. 2, an adequate flow of water must also be injected into the circuits to cool the mirrors 11, 12.

All the mirrors 11-13 inside the deflection device 10, preferably when used for long pulses and CW operations with high-powered microwaves, must be actively cooled with water during gyrotron pulses. In order to prevent the pipes of the cooling circuit 40 from being in direct contact with the vacuum volume inside the deflection device 10 or to prevent any welds from forming a boundary between the cooling means and the vacuum (a normally compulsory constraint in most fusion plants), the mirrors 11-13 of the deflection device 10 are designed following a technique already used for cooling the scattering mirror 23 at the rear of the load 20.

This cooling technique for mirrors 11-13, 23 consists of a hollow copper cylinder mounted on a metal sealing vacuum flange (such as those manufactured under the ConFlat® brand name), the diameter of which depends on the diameter of the mirrors 11-13, 23. The side under vacuum of the cylinder is machined in such a way as to obtain an adequate reflective surface, so as to act as a quasi-optical mirror 11-13, 23 for the incident rays of the microwave beam 100. The gap houses a water injection system 40, installed to provide adequate water cooling from the outside to extract heat from the internal reflective surface (vacuum), by efficient heat exchange through the copper thickness of the cylinder.

More generally, as shown in FIG. 2, the mirrors 11, 12, not only the first 11 and the second 12 but also the third mirror 13, if there is one, consist of a cylinder 45 made of thermally conductive material, comprising a hollow part (not under vacuum) which opens outwards from the deflection device 10 and comprising an external cooling system 40, preferably active and preferably with water, adapted to exchange heat with the thermally conductive material.

The cylinder 45 comprises an outer part which is enclosed within the cavity of the deflection device 10, wherein the external part of the cylinder 45 comprises surfaces directly contacting the vacuum of the cavity of the deflection device 10. One surface of the outer wall of the cylinder 45 is shaped to form the mirror 11, 12, 13.

The conducting cylinder is preferably made of copper.

Alternatively, it is possible to provide that the microwave absorption system could be applied to other technical fields and not necessarily to heating systems for nuclear fusion reactors.

Alternatively, a length of an optical path of the microwave beam 100 between the two mirrors 11, 12 is essentially equal to the sum of the focal lengths of the two mirrors 11, 12, where it essentially means a variation of about 10%.

Advantageously, the apparatus 50 according to the present invention provided with the spherical load 20 tested by the ISTP for 170 GHz can also be used for multi-frequency applications and/or at single frequencies lower that 170 GHz, or at frequencies of 170 GHz or higher in case of need for lower reflection coefficients or higher power handling without substantial modifications.

Advantageously, the positioning of the load 20 off-axis with respect to the beam coming from the transmission line 30 implies that the amount of radiation that can be directly back-reflected in the output direction W is extremely low.

Advantageously, the relatively large volume which would be added by installing the deflection device 10 instead of a pre-load of the state of the prior art, together with the large absorbing surfaces of the internal walls of the cavity of the deflection device 10 and/or of the additional cooled flanges 35 leads to lower local thermal loads on all the heated internal parts of the cavity of the deflection device 10.

Advantageously, the accuracy of the calorimetric power measurement of the system consisting of the cavity 20 with the deflection device 10 is improved, as the cooling circuits of the walls of the deflection device 10 and/or the absorbing flanges installed with the body of the deflection device 10 are included in the power balance transmitted to the cooling circuits, increasing the measurement accuracy.

Advantageously, the positioning of the optical fibres for monitoring the arcs as well as the cameras for detecting the visible light from the evacuated volume can be improved with the deflection device 10 compared to their positioning allowed on the pre-load currently used in the state of the prior art, because the deflection device 10 allows to have larger walls where the flanges can be positioned.

Advantageously, the deflection device 10 also allows for a greater flexibility in terms of vacuum pumping line installation, in fact said pumping line can be installed in locations wherein the pumps can be relatively protected from direct radio-frequency reflections.

Regarding the manufacturing of said apparatus 50, it is possible to define a process for making said apparatus 50 for absorbing microwaves in the form of high-frequency microwave beams 100, wherein said apparatus 50 comprises the load 20 which is a bolometric device with a receiving cavity and comprises the hollow body 21 with a receiving cavity comprising the opening 25 for the entry of the incident microwave beam 100 into the receiving cavity, the scattering element 23 adapted to reflect the multiplicity of components of said incident microwave beam 100 towards the multiplicity of reflection angles by directing the multiplicity of components of reflected microwave beam 100 towards an internal surface 22 of the cavity. Said process comprises a step of connecting a deflection device 10 of microwave beams 100 to the opening 25 of the load 20.

Said deflection device 10 comprises the body comprising the cavity, the first opening 15 of the cavity connected with said opening 25 of the cavity of the load 20 and a second opening 16 of the cavity connected with transmission lines 30 of the microwave beam 100 adapted to transport the microwave beams 100 from the source to the deflection device 10.

The cavity of said deflection device 10 comprises therein at least two converging mirrors 11, 12 arranged off-axis.

Alternatively, the load 20 may include a cavity with a shape other than the sphere, such as a cylindrical shape or other shape.

Alternatively, and more generally, the load 20 may comprise scattering means other than the scattering mirror 23 shown in FIGS. 1-4, more generally we can talk of scattering elements 23.

More generally, loads 20 other than those shown in FIGS. 1-4 and can be used in the embodiment described above. The major differences between different types of loads 20 consist in the scattering concept, the method and absorbing material, and the size and shape of the main body 21. The load developed by the ISTP is the only one provided with a spherical design as the one shown in FIGS. 1-4, and prototypes at 170 GHz have mainly been developed at the ISTP in recent years for applications in the test and development of the European gyrotron for ITER. More generally, the loads 20 must comply with a number of fundamental properties that are compulsory for their suitability in high-power systems. The loads 20 must ensure a low reflectivity (in the order of magnitude of 1% or less) for safe operation of the sources, since backward reflections towards the transmission line along the direction of incidence Z can become a serious problem for the safety of gyrotron-type sources and their stable operation, and for precision power measurements. In addition, the load 20 must be spatially compact in order to occupy as little space as possible, allowing for flexible integration with test facilities and/or in tokamak environments, where a large amount of space consumption is usually not permitted and the installation of a large number of components in close proximity to the tokamak can become a major problem. The load 20 must be compatible for use under vacuum, as powerful microwave beams 100 in the air can generate arcs, i.e. plasma points fed by the power of the microwaves returning to the sources. The arches have high reflections, preventing the use of sources. The need for compatibility of the load 20 with vacuum operations implies that all the internal materials must ensure adequate conditioning as well as high qualification in order to be suitable for the nuclear environment, if connected to the reactor. The design of the load 20 must be such that the heat exchange with the external cooling water for measuring the calorimetric output is as efficient as possible, so as to avoid that even small percentages of heat are distributed to non-cooled parts, causing overheating and undesirable accumulation of heat that should instead be transferred to the water and measured.

Alternatively, other types of loads 20 involve similar “cavity” concepts (e.g. cavities with a cylindrical geometry, with or without an internal absorbing cover), with differences in cover material (e.g. titanium oxide) and scattering method (e.g. the scattering element 23 can be understood as one or more cones or one or more rotating mirrors) and “lossy waveguide” concepts wherein a partial absorption is achieved on the internal surface of a waveguide with a duly shaped internal wall. These loads 20 are usually less compact than the spherical load and can have more reflections.

Alternatively, and more generally, the load 20 is a bolometric device with a receiving cavity and comprises a hollow body 21 with a receiving cavity comprising an opening 25 for the entry of the microwave beam 100 into the receiving cavity. The load 20 comprises a scattering element 23 adapted to reflect a multiplicity of components of said microwave beam 100 incident towards a multiplicity of reflection angles directed towards the internal surface 22 of the cavity.

Alternatively, the converging mirrors 11, 12 may be elliptical, paraboloid, hyperbolic, spherical mirrors or with a cross-section of another shape comprising any section of a geometric cone that allows to have converging mirrors.

One mirror may have one shape and the other can have another one, e.g. the first mirror 11 may be elliptical and the second mirror 12 paraboloid or vice versa or any of the shapes listed in the previous paragraph.

Alternatively said at least two convergent mirrors 11, 12 are a first converging mirror 11 suitable for intercepting the incident microwave beam 100 exiting the transmission line 30 whose focal axis is not necessarily aligned with the output direction W, and a second converging mirror 12 suitable for intercepting the incident microwave beam 100 by deflecting it towards the opening 25 of the load 10 and whose focal axis is not necessarily aligned with the input direction Z.

Alternatively, the third mirror 13 may be a convex mirror and therefore non-converging.

Alternatively, the third mirror 13 may be a diffractive element, such as a grating.

Alternatively, the third mirror 13 is a polarising mirror.

Alternatively, said cavity of said deflection device 10 comprises within itself at least a third non-converging mirror 13 inserted along an optical path between said at least two converging mirrors 11, 12.

Still alternatively said cavity of said deflection device 10 comprises within itself a multiplicity of non-converging third mirrors 13 inserted along an optical path between said at least two converging mirrors 11, 12.

Alternatively the external walls of the cavity of the deflection device 10 are cooled by means of integrated cooling circuits that can be active or passive.

Alternatively, the cylinder 45 can be made of other thermally conductive materials capable of exchanging heat with the cooling system 40.

Alternatively, not all the entire internal surface of the cavity of the deflection device 10 is covered with absorbing material, but only a portion of the surface.

Alternatively, the internal walls of additional flanges for further instrumentation are also coated with the scattered radiation absorbing material.

It is possible to provide that these additional flanges with internal surfaces coated with absorbing material can be seen as at least a portion of the internal walls of the cavity of the deflection device 10.

Alternatively, the flanges can be removable.

The invention thus conceived is susceptible to many modifications and variants, all falling within the same inventive concept. In practice, the materials used, as well as their dimensions, can be of any type according to the technical requirements.

1. An apparatus for absorbing high-frequency, high-power microwave beams, the apparatus comprising:
a load; and
a deflection device for the microwave beams;
wherein the load is a bolometric device, comprising:
a first body with a first cavity comprising a first opening for entry of an incident microwave beam into the first cavity; and
a scattering element configured to reflect a multiplicity of components of the incident microwave beam toward a multiplicity of angles of reflection by directing a multiplicity of components of the reflected incident microwave beam toward an internal surface of the first cavity;
wherein the deflection device comprises a second body comprising a second cavity that comprises second and third openings,
wherein the second opening of the second cavity is connected with the first opening of the first cavity,
wherein the third opening of the second cavity is configured to connect with transmission lines configured to transport the microwave beams from a source to the deflection device,
wherein the second cavity of the deflection device comprises at least two converging mirrors,
wherein the at least two converging mirrors comprise:
a first converging mirror configured to intercept the incident microwave beam exiting the transmission lines; and
a second converging mirror configured to intercept the incident microwave beam by deflecting the incident microwave beam toward the first opening of the load; and
wherein a length of an optical path of the incident microwave beam between the at least two converging mirrors is substantially equal to a sum of focal lengths of the at least two converging mirrors.

2. The apparatus of claim 1, wherein the first converging mirror comprises a first focal axis directed along an output direction of the apparatus, and
wherein the second converging mirror comprises a second focal axis directed along an input direction of the apparatus.

3. The apparatus of claim 1, wherein the second cavity of the deflection device comprises at least one third mirror along the optical path of the incident microwave beam between the at least two converging mirrors.

4. The apparatus of claim 3, wherein the at least one third mirror is non-converging.

5. The apparatus of claim 3, wherein the at least one third mirror is a plane mirror comprising a geometric normal forming an acute angle with an input direction of the apparatus.

6. The apparatus of claim 3, wherein the at least one third mirror is a polarising mirror.

7. The apparatus of claim 1, wherein the second cavity of the deflection device comprises metal walls and is under vacuum.

8. The apparatus of claim 1, wherein the second cavity of the deflection device comprises at least a portion of internal walls comprising a layer of diffuse radiation absorbing material.

9. The apparatus of claim 1, wherein external cavity walls of the deflection device are cooled using integrated cooling circuits.

10. The apparatus of claim 1, wherein one or more of the at least two converging mirrors comprises a cylinder made of heat conducting material,
wherein the cylinder comprises;
a hollow internal part opening to an outside of the deflection device;
an external cooling system configured to exchange heat with the heat conducting material; and
an outer part enclosed within the first cavity of the deflection device;
wherein the outer part of the cylinder comprises surfaces directly in contact with a vacuum of the second cavity of the deflection device, and
wherein a surface of an outer wall of the cylinder is shaped to form the one or more of the at least two converging mirrors.

11. The apparatus of claim 1, further comprising:
at least one flange comprising vacuum-compatible bellows;
backwardly reflecting inner walls, wherein the backward direction is toward the load; or
the at least one flange comprising vacuum-compatible bellows and the backwardly reflecting inner walls.

12. The apparatus of claim 1, wherein the deflection device comprises walls with flanges for installation of further instrumentation.

13. A process for realizing a microwave absorption apparatus in a form of high-frequency microwave beams,
wherein the apparatus comprises a load which is a bolometric device with a receiving cavity and comprises;
a hollow body with the receiving cavity comprising an opening for entry of an incident microwave beam into the receiving cavity; and
a scattering element configured to reflect a multiplicity of components of the microwave beam incident toward a multiplicity of angles of reflection by directing a multiplicity of components of the reflected microwave beam toward an internal surface of the receiving cavity;
wherein the process comprises:
connecting a deflection device of microwave beams to the opening of the load;
wherein the deflection device comprises a body comprising a cavity, a first opening of the cavity connected with the opening of the load cavity, and a second opening of the cavity configured to be connected with transmission lines of the microwave beams configured to transport the microwave beams from a source to the deflection device,
wherein the cavity of the deflection device comprises at least two converging mirrors,
wherein the at least two converging mirrors comprise:
a first converging mirror configured to intercept the incident microwave beam exiting the transmission lines;
a second converging mirror configured to intercept the incident microwave beam by deflecting the incident microwave beam toward the opening of the load; and
wherein a length of an optical path of the incident microwave beam between the at least two converging mirrors is substantially equal to a sum of the focal lengths of the at least two converging mirrors.

14. The process of claim 13, further comprising:
admitting the incident microwave beam along an input direction of the apparatus.

15. A microwave absorption system comprising the apparatus of claim 1.

16. A plasma heating system comprising the apparatus of claim 1.

17. A nuclear fusion reactor comprising the apparatus of claim 1.

18. The apparatus of claim 1, wherein the length of the optical path of the incident microwave beam between the at least two converging mirrors is greater than or equal to 90% of the sum of the focal lengths of the at least two converging mirrors and is less than or equal to 110% of the sum of the focal lengths of the at least two converging mirrors.

19. The apparatus of claim 3, wherein although the at least one third mirror is along the optical path of the incident microwave beam between the at least two converging mirrors, the at least one third mirror is not directly between the at least two converging mirrors.

20. The apparatus of claim 4, wherein the at least one non-converging third mirror comprises a cylinder made of heat conducting material,
wherein the cylinder comprises:
a hollow internal part opening to an outside of the deflection device;
an external cooling system configured to exchange heat with the heat conducting material; and
an outer part enclosed within the first cavity of the deflection device;
wherein the outer part of the cylinder comprises surfaces directly in contact with a vacuum of the second cavity of the deflection device, and
wherein a surface of an outer wall of the cylinder is shaped to form the at least one non-converging third mirror.
